(19) United States
(12) Patent Application Publication
(10) Pub. No.: US 2006/0125192 A1
(43) Pub. Date: Jun. 15, 2006

(54) Shaft seal having a hinge and a liner

(75) Inventor: David Ernest Johnston, East Hebron, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/351,493

(22) Filed: Feb. 10, 2006

Related U.S. Application Data
(63) Continuation of application No. 10/081,130, filed on Feb. 22, 2002.
(63) Continuation of application No. 09/494,050, filed on Jan. 28, 2000, now Pat. No. 6,428,013.
(60) Provisional application No. 60/270,803, filed on Feb. 23, 2001.
(60) Provisional application No. 60/117,723, filed on Jan. 29, 1999.

(51) Int. Cl. F16J 15/32

(52) U.S. Cl. 277/559; 277/400

(57) ABSTRACT

A seal assembly for use with a rotating element such as a shaft includes a case having an axial portion and a radial portion. A seal body is bonded to at least the radial portion of the case. A hinge is bonded to the seal body adjacent to a terminating section of the radial portion of the case. A lip is bonded to the hinge. A liner is attached to the lip. The majority of bending loads and stresses are incurred in the hinge, thus increasing the life of the liner.

### CROSS-REFERENCE TO RELATED APPLICATIONS

This application is a continuation of U.S. patent application Ser. No. 10/081,130 filed Feb. 22, 2002, which claims the benefit of U.S. provisional Patent Application No. 60/270,803, filed Feb. 23, 2001, and is a continuation of U.S. patent application Ser. No. 09/494,050, filed Jan. 28, 2000, now U.S. Pat. No. 6,428,013, which claims the benefit of U.S. provisional Patent Application No. 60/117,723, filed Jan. 29, 1999.

### BACKGROUND

The statements in this section merely provide background information related to the present disclosure and may not constitute prior art.

This invention relates in general to seal assemblies for use in sealing a lubricant about a rotating element, such as a shaft. More specifically, this invention relates to a shaft seal of the type having a flexible lip that contacts the rotating shaft.

Flexible lips are bonded to housings and the like to form lip seals for sealing about rotating shafts. A lip of such a seal is subjected to bending loads and stresses, which reduces the life of the lip. Oftentimes, the lip is formed from an elastomeric element such as rubber. A lip seal retains lubricant on an oil side of the seal and prevents the entry of contaminants from an air side of the seal.

A wear surface can be formed from a reduced-friction material, such as polytetrafluoroethylene (PTFE). For example, U.S. Pat. No. 6,168,164 B1 discloses a shaft seal having a seal element formed from a polymer material, such as polytetrafluoroethylene. Such construction results in bending loads and stresses on the polymer material, thus reducing its life.

### SUMMARY

The present invention includes a shaft seal having a liner formed from a polymer material attached to an elastomeric hinge and lip portion of a seal body. The hinge and lip incur the majority of the bending loads and stresses, thus increasing the life of the liner. The liner provides a reduced-friction contact surface to the rotating element. The life and performance of the shaft seal assembly is improved.

In a preferred embodiment, a seal assembly for use with a rotating element such as a shaft includes a case having an axial portion and a radial portion. A seal body is bonded to at least the radial portion of the case. A hinge is bonded to the seal body adjacent to a terminating section of the radial portion of the case. A lip is bonded to the hinge. A liner is attached to the lip. The majority of bending loads and stresses are incurred in the hinge, thus increasing the life of the liner. Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a sectional, partial view of a first preferred embodiment of a seal assembly according to this invention;

FIG. 2 is a sectional, partial view of a second preferred embodiment of a seal assembly according to this invention mounted on a rotating element; and

FIG. 3 is an enlarged view of a portion of seal assembly of FIG. 2 contained in circle A, illustrating a lip portion and a liner.

### DETAILED DESCRIPTION

The following description is merely exemplary in nature and is not intended to limit the present disclosure, application, or uses. It should be understood that throughout the drawings, corresponding reference numerals indicate like or corresponding parts and features.

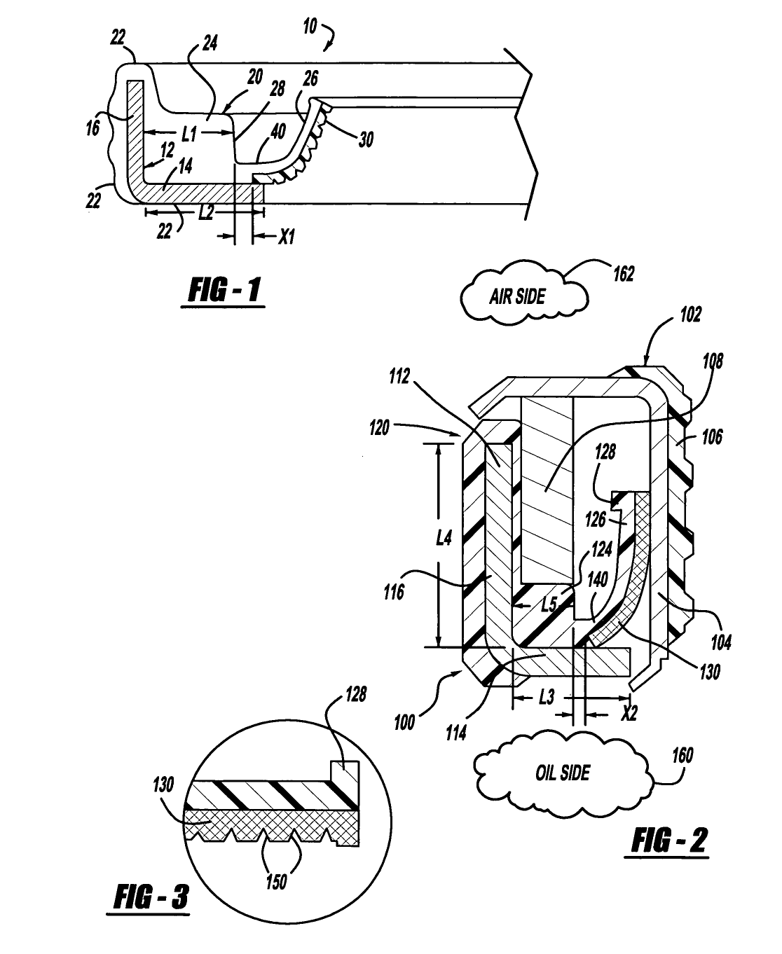

A first embodiment of a seal assembly is indicated generally at 10 in FIG. 1. The seal assembly 10 is illustrated prior to installation on a rotating element (not shown), such as a shaft. The seal assembly 10 includes a rigid case 12 and an elastomeric seal body 20 molded to the case 12. The seal assembly 10 is molded by compression, transfer, or injection molding process, or a combination of these processes, or similar processes. When the molding process is complete, flash 22 may be present at various outer surfaces of the seal assembly. Preferably, the flash 22 is removed prior to installation on a rotating member.

The case 12 is an annular member having a radial portion 14 and an axial portion 16. Preferably, the axial portion 16 is formed approximately perpendicular to the radial portion 14.

The seal body 20 includes a bonding or radial portion 24 and a flexible lip portion 26. The radial portion 24 is formed so that an inner radial boundary 28 is formed with a length L1 less than a length L2 of the radial portion 14 of the case 12. The lip portion 26 has a length that covers (extends over) and is in contact with at least a portion of the length L2 of the radial portion 14.

A liner 30 preferably formed from polytetrafluoroethylene is bonded to an inner surface of the lip portion 26. The liner 30 has a length that begins adjacent the radial portion 14 and extends preferably to a terminating point of the lip portion 26. However, a distance X1 is provided between an originating point of the liner 30 and the radial boundary 28.

When the lip portion 26 and liner 30 are flexed (as shown in FIG. 1) to accommodate a shaft or other rotating member (not illustrated), a hinge 40 is formed by the flexible lip portion 26. Thus, the lip portion 26 originates with the hinge 40. The hinge 40 receives or incurs the majority of bending loads and stresses as the lip portion 26 is flexed. Since the lip portion 26 is formed from a more durable material, such as a rubber, the lip portion 26 can withstand these loads. The liner 30 is attached to this hinge 40 and is subject to less stress than the hinge 40. Thus, the liner 30 has improved durability and longer life.

A second embodiment of a seal assembly 100 according to this invention is partially illustrated in FIGS. 2 and 3. The seal assembly 100 is shown mounted on a rotating shaft 102. The rotating shaft 102 includes a rigid case 104 and an elastomer 106 bonded to the case 104. A spacer 108, preferably formed from Nylon, is provided between the seal assembly 100 and the rotating shaft 102.

The seal assembly 100 is very similar to seal assembly 10. The seal assembly 100 includes a rigid case 112 having a radial portion 114 and an axial portion 116. In this embodiment, the length L3 of the radial portion 114 is less than a length L4 of the axial portion 116.

The seal assembly 100 also includes a seal body 120 having a bonding portion 124 and a flexible lip portion 126. The length L5 of the bonding portion 124 is less than the length L3 of the radial portion 114 so that the lip portion 126 is adjacent at least a portion of the radial portion 114.

A liner 130 is provided on an inner surface of the lip portion 126. Preferably, the liner 130 is formed from polytetrafluoroethylene. A distance X2 is provided between the start of the lip portion 126 and the start of the liner 130. In this manner, the liner 130 is subjected to less stress as a hinge 140 accommodates a majority of the bending stresses when the lip portion 126 and liner 130 are flexed to accommodate the rotating member 102.

The lip portion 126 can terminate in a raised portion 128, in the form of a ring, bead, or other desired shape. As illustrated in FIG. 3, grooves 150 can be provided in an inner surface of the liner 130. If desired, a light film of lubricant such as grease can be applied to a contacting surface of the liner 130.

A lubricant, such as oil, is retained in an oil side 160 of the seal assembly 100. Oil is prevented from leaking to an air side 162 of the seal assembly 100. The seal assembly 100 blocks contaminants from the air side 162.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A shaft seal mounted on a rotatable shaft to prevent the migration of fluid from an oil side to an air side, said shaft seal comprising:
a case member; and
a primary fluoropolymer seal ring attached to said case member, said primary seal ring having one end in sealing contact with the shaft;
said one end having a fluid control surface and at least one hydrodynamic groove in said fluid control surface, said one end extending toward the air side.
